(19) United States
(12) Patent Application Publication
(10) Pub. No.: US 2008/0174519 A1
(43) Pub. Date: Jul. 24, 2008

(54) RECONFIGURABLE COLOR SIGNAGE USING BISTABLE LIGHT VALVE

(76) Inventors: Chan-Long Shieh, Paradise Valley, AZ (US); Hsing-Chung Lee, Calabasas, CA (US)

Correspondence Address: ROBERT A. PARSONS, 4000 N. CENTRAL AVENUE, SUITE 1220, PHOENIX, AZ, 85012, US

(21) Appl. No.: 11/625,904

(22) Filed: Jan. 23, 2007

(51) Int. Cl. G09G 3/20

(52) U.S. Cl. 345/55

(57) ABSTRACT

Reconfigurable color signage includes an array of light valves each having memory. An active matrix including a plurality of conductive select and data lines is positioned on one side of the array. Each light valve is electrically coupled to be separately addressable by a unique combination of select and data line. The active matrix has a write mode in which signals are supplied to each light valve to provide a selected light transmittance and a display mode in which the memory of each light valve retains the selected transmittance after the signals of the write mode have been removed. A backlight is positioned to direct light in a light path through the array and a color filter is positioned in the light path to define a plurality of pixels, including one red, green, and blue filter for each pixel, and each positioned to be associated with a separate light valve.

### FIELD OF THE INVENTION

This invention generally relates to color signage and the like and more specifically to color signage using an array of bistable light valves.

### BACKGROUND OF THE INVENTION

There is a strong motivation to replace color paper signage with reconfigurable electronic signage. LED and LCD types of arrays have been used in displays for this application. Both of these types of arrays do not have memory and the image has to be refreshed constantly. The refreshing circuitry is expensive and power hungry.

It would be highly advantageous, therefore, to remedy the foregoing and other deficiencies inherent in the prior art.

Accordingly, it is an object of the present invention to provide a new and improved reconfigurable color signage display with memory.

### SUMMARY OF THE INVENTION

Briefly, to achieve the desired objects of the instant invention in accordance with a preferred embodiment thereof, provided is a reconfigurable color signage including an array of light valves each having memory. An active matrix is positioned on one side of the array and includes a plurality of conductive select and data lines. Each light valve is electrically coupled to one of the plurality of select lines and to one of the data lines such that each light valve is separately addressable by a unique combination of select line and data line. The active matrix has a write mode in which signals are supplied to each light valve to provide a selected light transmittance and a display mode in which the memory of each light valve retains the selected transmittance after the signals of the write mode have been removed. A backlight is positioned to direct light through the array of light valves and a color filter in the light path whereby transmittance of light by each light valve of the array of light valves is reconfigurable to effect signage. The color filter is positioned either in front or behind the array of light valves and is formed and positioned to separate light from the light valves into different colors.

The desired objects of the instant invention and others are further achieved in a specific embodiment through a reconfigurable color signage including an array of light valves including either electrophoretic cells or electrochromic cells each having memory. An active matrix is positioned on one surface of the array and includes a plurality of conductive select lines and a plurality of conductive data lines. Each light valve is electrically coupled to one of the select lines and to one of the data lines such that each light valve is separately addressable by a unique combination of select line and data line. The active matrix has a write mode in which signals are supplied to each light valve to provide a selected light transmittance and a display mode in which the memory of each light valve retains the selected transmittance after the signals of the write mode have been removed. Drivers are coupled to one of the select lines and the data lines of the active matrix through demux circuits. The active matrix is formed on a transparent substrate and includes transparent conductors. A backlight is positioned to direct light through the array of light valves and a color filter positioned in the light path whereby transmission of light by each light valve is reconfigurable to effect signage. The color filter is positioned either in front or behind the array of light valves and is formed and positioned to define a plurality of pixels. Each pixel includes one red filter, one green filter, and one blue filter. The red filter, the green filter, and the blue filter of each pixel are positioned to be in the light path of light transmitted by three separate light valves in each pixel. An optional diffuser is positioned to diffuse light emanating from the array of light valves and the color filter to provide better color uniformity by an observer.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified side view of an embodiment of a color signage with memory in accordance with the present invention;

FIG. 2 is a simplified exploded view in perspective of one embodiment of a light valve array with memory including electrophoretic cells and a thin film diode active matrix;

FIG. 3 is an enlarged portion of a small area of FIG. 2;

FIG. 4 is an enlarged and simplified sectional view of one embodiment of a thin film diode and integrated resistor combination;

FIG. 5 is an enlarged and simplified sectional view of another embodiment of a thin film diode and integrated resistor combination;

FIG. 6 is a simplified exploded view in perspective of another embodiment of a light valve array with memory including electrophoretic cells and thin film diode active matrix with write memory;

FIG. 7 is an enlarged portion of a small area of FIG. 4;

FIG. 8 is a schematic representation of a single light valve in a TFT active matrix;

FIG. 9 is a schematic diagram of an embodiment of a diode/resistor implemented 1×n demux circuit; and

FIG. 10 is a schematic diagram of an embodiment of a thin-film-transistor (TFT) implemented 1×n demux circuit.

### DETAILED DESCRIPTION OF A PREFERRED EMBODIMENT

New classes of display technologies have been developed to exhibit memory characteristics, i.e. when an applied voltage is removed from a pixel the state of the pixel remains the same. Electrophoretic displays or EPDs and electrochromic displays or ECDs are two of the main contenders in this field. Electrophoretic materials include particles that move through or rotate within a suspending material. Electrophoretic displays (EPDs) change transmittance based on charged moving particles. One major advantage of EPDs is the low manufacturing cost due to high production throughput associated with the use of flexible substrates.

One EPD material that is used as an example in the present application is one in which charged particles move within a layer of suspending material to one surface or the other when an electric field of a specific polarity is applied across the layer. In a typical example, the particles are opaque and positively charged so that they are drawn to a surface having a negative voltage applied relative to the opposed surface. In this example, the size or area of the electrodes is different on opposite surfaces of the light cell. The opaque particles can be concentrated onto a smaller electrode to allow transmission of light through the light valve or the opaque particles can be spread across a larger electrode to substantially block transmission of light, depending upon the selected polarity of the cell.

Once the particles are attracted to the surface by the negative or positive voltage, they remain adjacent to the surface even when the negative or positive voltage is removed. This is referred to as having a memory. Even Brownian movement appears to have little or no effect on the particles. Further, as an example, the light cell can be opaque by applying a negative (or positive) voltage to the larger electrode and a positive (or negative) voltage to the smaller electrode or opposed surface, the opaque particles spread across the surface of the light valve and the light valve has a low light transmittance (dark). The light valve has a high light transmittance (light) when a reverse polarity is applied, thereby concentrating the opaque particles at the smaller area electrode. Intermediate voltages on the electrodes provide intermediate amounts of light transmittance. Therefore, a display is produced by providing different size electrodes on opposite sides of an array of electrophoretic cells and activating the electrodes to cause each of the cells to be light, dark, or at some intermediate selected light transmittance. It will of course be understood that this is simply one example of a transmissive light valve and other structures or embodiments can be devised.

The present invention discloses color signage using light valves that have memory. As explained above, examples of these light valves are transmissive electrophoretic displays (EPD) and electrochromic displays (ECD). By using light valves with memory, there is no need to refresh the display and the image can be written at a much slower rate without concern for flickering. That is, the display has an active matrix with a write mode in which signals are supplied to each light valve of the array of light valves to provide a selected light transmittance. Between write modes and practically without regard for the length of time, the active matrix is in a display mode in which the memory of each light valve retains the selected transmittance after the signals of the write mode, or power on the active matrix, have been removed. As a result, the requirements for the backplane and the driver are relaxed. The driver cost can be further reduced by implementing demux circuits with the back plane technology. For a display requiring a high refresh rate, this circuitry is not viable because of the lack of performance from the back plane technology. By using light valves with memory, there is no constraint on the frame time and the back plane technology has sufficient performance to implement demux circuitry to reduce the number of drivers. Furthermore, less expensive backplane technology with relatively poor performance can be used. Examples of this circuitry are organic thin-film-transistors (TFT) or thin film diodes (TFDs), which can be used to replace expensive a-Si TFTs. Organic TFTs and/or organic thin film diodes have enough performance to implement the backplane and demux circuits.

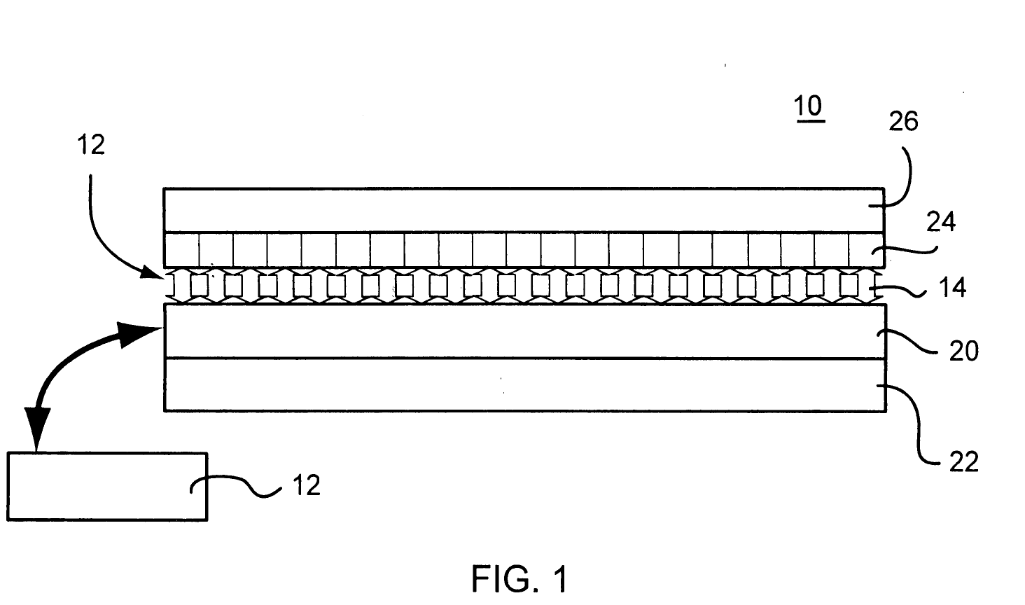

Turning now to the drawings, attention is first directed to FIG. 1, which illustrates a simplified side view of color signage with memory, generally designated 10, in accordance with the present invention. Color signage 10 includes an array of light valves 14 hereinafter referred to as display panel 12, a backplane 20 on a reverse side of display panel 12, a backlight 22 on the opposite side of backplane 20, a color filter 24 on the front side of display panel 12, and a diffuser 26 on the front or viewing side of color filter 24. Here it should be understood that the specific arrangement illustrated is for purposes of explanation and other arrangements could be utilized if desired. For example, backplane 20 could be disposed on the front side of display panel 12, since backplane 20 is formed on a transparent substrate with at least some transparent conducting lines (i.e. those in the light path). Also, color filter 24 is simply placed in the light path of light emanating from backlight 22 so that light transmitted through each specific light valve in display panel 12 is associated with a desired color. That is, color filter 24 could be placed between back light 22 and display panel 12 or in front of display panel 12 (as illustrated). Also, in some applications light valves 14 and color filter 24 may produce large enough pixels that the three colors of the pixels may not be properly mixed by the natural characteristics of the human eye to provide the correct tones, in such instances diffuser 26 is included to provide the required mixing.

In the specific embodiment illustrated in FIG. 1, display panel 12 includes electrophoretic light valves or cells 14 but it will be understood from the disclosure that any light valve with a memory, including for example EPD and ECD light valves, could be used. Also, it will be understood that cells 14 can be formed as a plurality of individual or unitary cells distributed in rows and columns, elongated cells can be divided into rows or columns, or the entire panel 12 can be formed as a single unit with the control matrix or backplane 20 separating it into smaller cells or areas. Driver circuit 16 contains drivers and other circuitry for effecting desired messages on signage 10. Driver 16 can also include ICs for either wire or wireless communication by which the desired messages can be entered.

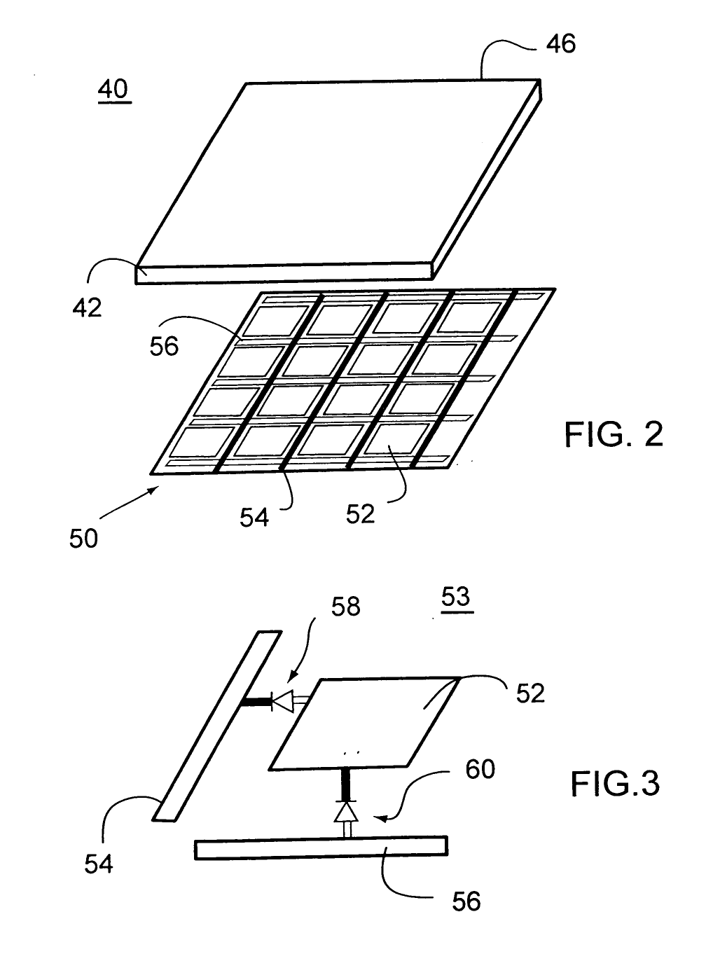

Turning now to FIGS. 2 and 3, an example of display panel 12 and backplane 20 of FIG. 1 is embodied in a light valve display 40 that includes electrophoretic cells with memory and a thin film diode active matrix. Display 40 includes a display panel 42 which, as explained above, can be formed as a single unit or can be divided into an array of cells with elongated cells arranged in rows or columns, or square cells arranged in rows and columns, or any other desired configuration. A common transparent conductive plane 46 is deposited on the upper or visible surface of display panel 42.

A backplane 50 is laminated to the rear surface of panel 42 and contains an active matrix including an array of transparent conductive elements or pads 52. Each conductive pad 52 forms a light valve or cell 53 (designated 14 in FIG. 1) in conjunction with common transparent conductive plane 46. Here it should be noted that elements or pads 52 could be the smaller area electrodes mentioned in the above example of a light valve with light transmittance or common transparent conductive plane 46 could be formed with an array of smaller conductive areas (e.g. smaller interconnected transparent conductive pads). Also, each light valve or cell 53 has memory as explained above. Further, as is understood in the art, three light valves or cells 53, each having a different color (e.g. red, green, and blue) are arranged to form a single pixel. Data lines 54 extend vertically between adjacent columns of pads 52, with one data line 54 for each column of pads 52, and select lines 56 extend horizontally between adjacent rows of pads 52, with one select line for each row of pads 52. It will of course be understood that there is no connection between data lines 54 and select lines 56 on the surface of panel 42. Also, it should be understood that the positions of the select and data lines are for purposes of this explanation and that the lines could be reversed if desired.

Because transparent conductive plane 46 is common, no alignment of cells 53 and backplane 50 is required during manufacture. Thus, manufacturing is greatly simplified since there are no electrical connections between display panel 42 and backplane 50 no critical alignment is necessary. For example, display panel 42 and backplane 50 could be manufactured separately and laminated together later or backplane 50 could be formed directly on the back of display 42. It will be understood from the following description that backplane 50 can be formed using virtually any convenient transparent material as a substrate. For example, the substrate can include glass, quartz, PET, polyimide (PI), etc. Also, at least some of the conducting lines of backplane 50 (i.e. those in the light path) are preferably formed of transparent conductors, such as transparent metals or polymers, so that light can readily be transmitted through backplane 50. Here also it should be noted that while transparent conductors are generally not as good at conducting electricity as metal conductors, the poorer conductance is acceptable because signals are only applied during the relatively slow reconfiguring of the signage (write mode).

Referring specifically to FIG. 3, it can be seen that in this embodiment each transparent conductive pad 52 is connected to one adjacent data line 54 of the plurality of vertically extending data lines 54 by a thin film diode and integrated resistor combination 58. Also, each pad 52 is connected to one adjacent select line 56 of the plurality of horizontally extending select lines 56 by a thin film diode and integrated resistor combination 60. It should also be noted that the diode in the combination 58 is oriented in reverse polarity to the diode in combination 60. That is, the anode of the diode in combination 58 is connected to pad 52 while the cathode of the diode in combination 60 is connected to pad 52. Because a single thin film diode (unidirectional) is used in this structure, the turn-on voltage for the diodes is very low, i.e. close to the voltage drop across a semiconductor junction or approximately 0.7 volts to 2 volts.

While it will be understood that integration of the diode and resistor combination is not required (i.e. they can be formed separately) integration is preferred because of the simplicity of manufacturing. Also, the diodes in the diode/resistor combinations 58 and 60 are described in this preferred embodiment as thin film diodes but it should be understood that in some specific applications other diodes and resistors (i.e. discrete components) may be utilized if desired.

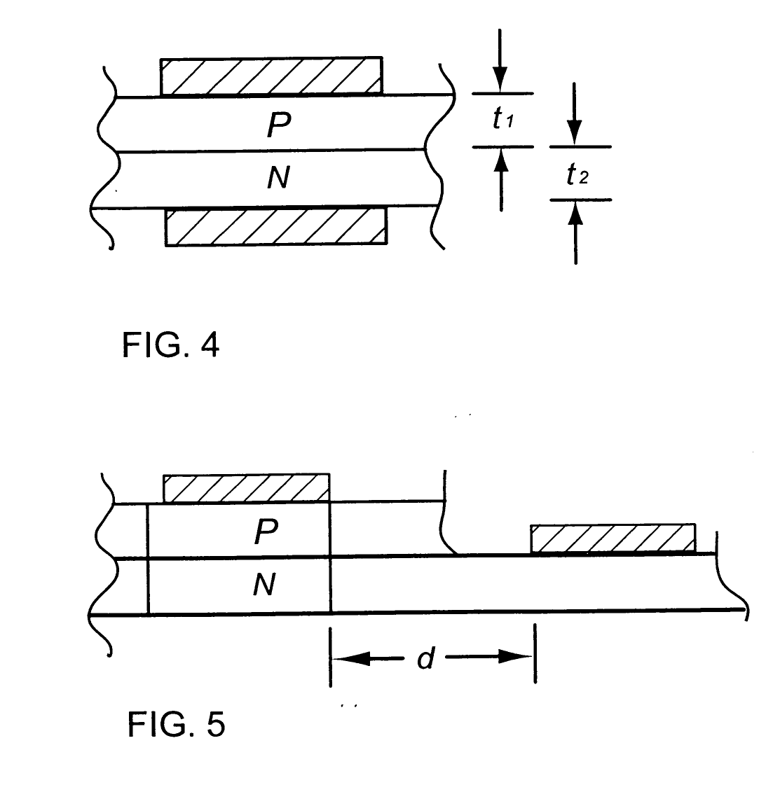

One example of an integrated diode/resistor combination is illustrated in FIG. 4. In this example the resistance is incorporated automatically (integrated) by adjusting the vertical thickness t₁ or t₂ of one or both of the p and n layers of the diode. A second example of an integrated diode/resistor combination is illustrated in FIG. 5. In this example, one of the electrical contacts for the diode is displaced laterally and the distance d determines the amount of resistance incorporated. The value of the resistors incorporated with the thin film diodes is preferably very large in order to reduce the power consumption. It should be understood that the resistor/diode combination can be fabricated using well known semiconductor materials or can be organic material printed, for example, directly on the back of display panel 42. For an example of printed organic diodes see copending U.S. patent application entitled “Polymeric/Organic Binders for Device Applications and Method”, bearing Ser. No. 10/, and filed, incorporated herein by reference. Since the semiconductor or organic material used in thin film diodes usually has a very low mobility/conductivity, it is quite suitable to make a large resistance resistor.

Referring additionally to FIG. 1, because of the memory in light valves or cells 14, it is generally desirable to reset a signage display before entering a new signage display. Common conductive pad 46 is used in the embodiment of FIG. 2 as a common reset input. In the operation of display 10, backplane 50 is energized into the write mode and all of the cells 14 are reset initially into the opaque state using a reset line. The light transmittance of each cell 14 is set to a selected value to provide the desired signage and backplane 50 is de-energized into the display mode. In the display mode no energy is required to be supplied to backplane 50 to retain the selected light transmittance of each cell 14 because of the memory in each cell 14. Additional operation of backplane 50 illustrated in FIGS. 2 and 3, is disclosed in copending U.S. Patent entitled “TFD Active Matrix”, bearing patent application Ser. No. 11/, filed on /2006, and incorporated herein by reference.

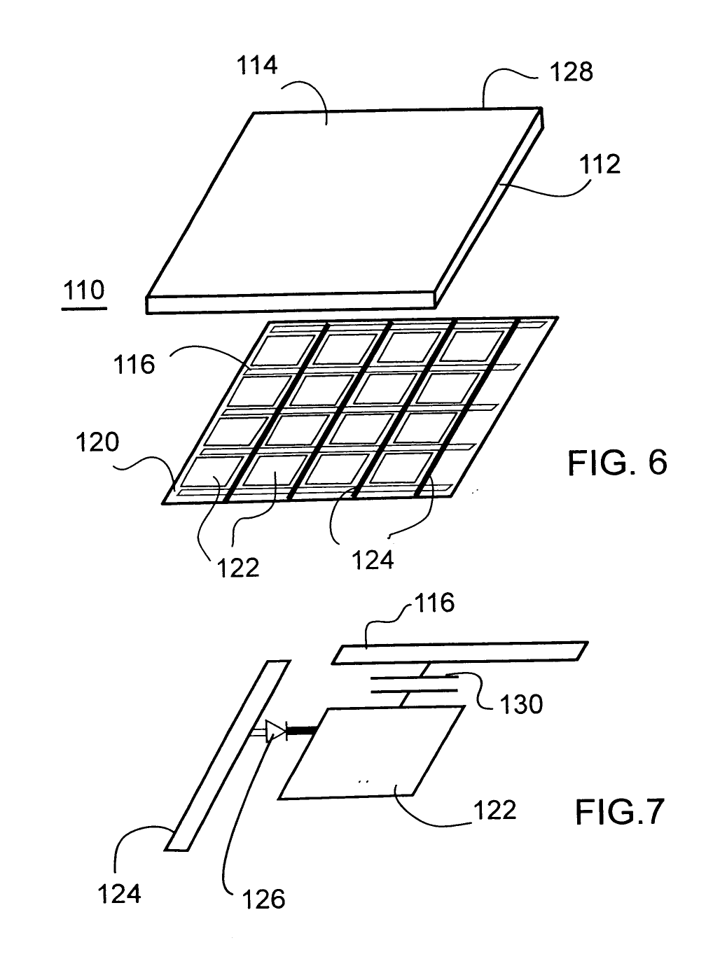

Another embodiment of a backplane for an array of light valves with memory is illustrated in FIGS. 6 and 7. In this embodiment a backplane 120 is laminated to the rear surface of a panel of electrophoretic material 112 and contains an active matrix including an array of transparent conductive pads 122, as illustrated in FIG. 6. Data lines 124 extend vertically between adjacent columns of conductive pads 122, with one data line 124 for each column of conductive pads 122, and select lines 126 extend horizontally between adjacent rows of conductive pads 122, with one select line for each row of conductive pads 122. It will of course be understood that there is no connection between data lines 124 and select lines 126 on the surface of panel 120. Also, it should be understood that the positions of the select lines and data lines are for purposes of this explanation and that the lines could be reversed or positioned differently if desired. Each conductive pad 122 is connected to one data line 124 of the plurality of vertically extending data lines 124 by a thin film diode 126, as illustrated in FIG. 7. Each conductive pad 122 is connected to one select line 116 of the plurality of horizontally extending select lines 116 by a storage capacitor 130, as illustrated in FIG. 7.

A common transparent conductive plane 128 is deposited on the upper surface of display panel 112. Here it should be noted that pads 122 could be the smaller area electrodes mentioned in the above example of a light valve with light transmittance or common transparent conductive plane 128 could be formed with an array of smaller conductive areas. Because conductive plane 128 is common, no alignment of cells and backplane 120 is required during manufacture (in the above example in which pads 122 are the smaller area electrodes). Thus, manufacturing is greatly simplified since there are no electrical connections between display panel 112 and backplane 120 and no critical alignment is necessary. For example, display panel 112 and backplane 120 could be manufactured separately and laminated together later or backplane 120 could be formed directly on the back of display 112. It will be understood from the following description that backplane 120 can be formed using virtually any convenient transparent material as a substrate. For example, the substrate can include glass, quartz, PET, polyimide (PI), etc.

Backplane 120 includes m horizontal select lines 116 and n vertical data lines 124 cooperating to divide display panel 112 into an array of m×n cells 114 each including one of the m×n transparent conductive pads 122. As is understood in the art, three cells 114 of different colors (e.g. red, green, and blue) are arranged to form a single pixel. Each cell 114 is addressed (or selected) through the specific select line 116 and the data line 124 connected to the specific conductive pad 122 on the lower surface. Further, by applying a predetermined voltage to the specific conductive pad 122 the selected cell 114 can be switched into a dark or light state as will be explained in more detail below.

It will be understood that the driver circuitry (e.g. driver 16 of FIG. 1) includes additional circuits (not shown) which are designed to select cells and pixels in some predetermined order and to apply preselected driving voltages in accordance with some selected data to be displayed. These additional circuits are well known in the art and are dependent upon specific applications so that further disclosure is not necessary to the understanding of the present invention and, therefore, will not be undertaken herein.

Storage capacitors 130 are relatively large and may, for example, be deposited under the reverse side of each conductive pad 122. This is easily accomplished by depositing a first plate of transparent conductive material for each capacitor on the surface of backplane 120, depositing a dielectric layer on the first plate, and then depositing conductive pad 122 over the dielectric. In this fashion storage capacitor 130 is automatically connected to conductive pad 122 and only a connection between select line 116 and the first plate is required. Here it will be noted, the intrinsic capacitance of the cell 114 (referred to in the text below as C_{EPD}) is a relatively small capacitance between each conductive pad 122 and conductive plane 128. It is well known that the intrinsic capacitance of the electrophoretic cell C_{EPD} is very small because of the relatively thick electrophoretic material in display panel 112 and, therefore, cannot be used as a storage capacitance.

In a preferred embodiment, diode 126, which is an asymmetric diode as explained above, is a printed diode such as Ta/TaO₂. Printed diodes can be fabricated on flexible substrates and are very convenient to manufacture. Printed diodes and the fabrication of flat panel displays is discussed in detail in copending U.S. Patent Application entitled “TFD Active Matrix”, bearing patent application Ser. No. 11/, filed on /2006, and incorporated herein by reference.

Because of the memory in light valves or cells 114, it is generally desirable to reset a signage display before entering a new signage display. Common conductive pad 128 is used in this embodiment as a common reset input. In the operation of display 112, backplane 120 is energized into the write mode and all of the cells 114 are reset initially into the opaque state by applying a reset voltage to common conductive pad 128.

After the reset, all lines are unselected by holding the voltage on the rows or select lines 116 at a predetermined voltage. Data is written into the storage capacitor 130 of each cell 114 by a column driver (not shown) on data line 124. Select line 116 of the cell being written is at a predetermined select voltage and all unselected lines are maintained at a predetermined unselect voltage. Also, common conductive plane 128 is maintained at a predetermined voltage. The data on data line 124 is determined by the desired brightness (transmittance) of the cell, which includes the desired color of the pixel. Thus, storage capacitor 130 of the selected cell is charged very rapidly to the write voltage on data line 124. For all unselected cells, the voltage on select lines 116 is held at a voltage that reverse biases diodes 126 so that the voltage on storage capacitors 130 in those cells is not affected. Thus, data can be written to the various cells at a relatively high rate because the voltage can be written at a relatively high rate and the voltage on each of the cells is maintained after the cell is no longer on a selected line. In this embodiment, the rate of writing is limited by the charging capacity of diode 126 instead of the response time of the cell 114.

After the writing process, the voltage across storage capacitor 130 depends on the written data (desired state or brightness and color of the cell). But, as the voltage on select line 116 changes from a selected cell to an unselected cell, the voltage on storage capacitor 130 changes depending on the written data, and the voltage across cell 114 changes depending on the written data. Thus, in this embodiment, the written data is actually applied to cell 114 after the cell is changed to an unselected cell. In this fashion, the light transmittance of each cell 114 is set to a selected value in the write mode to provide the desired signage after which backplane 120 is de-energized into the display mode. In the display mode no energy is required to be supplied to backplane 120 to retain the selected light transmittance of each cell 114 because of the memory in each cell 114.

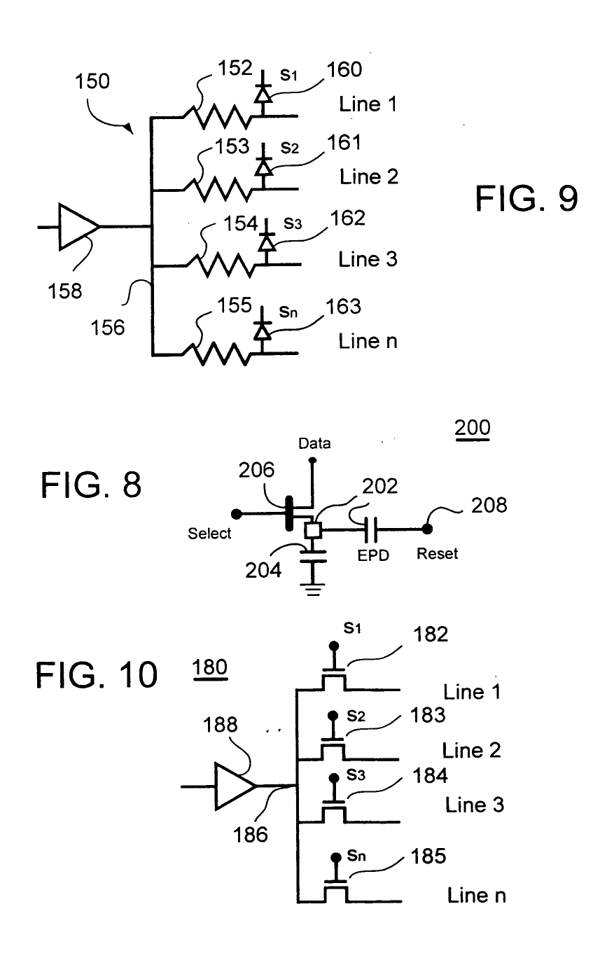

Turning to FIG. 8, a schematic representation of a light valve 200 in a display with a TFT (thin film transistor) active matrix is illustrated. In this embodiment, a transparent conductive element 202 is represented by a terminal coupled to ground through a storage capacitor 204. One conductive terminal (e.g. the source or drain) is connected to conductive pad 202, the other conductive terminal (i.e. the drain or source) is connected to a data line and the gate is connected to a select line. The common conductive plane, designated 208, of the display is connected to receive a reset signal (as described above). It will be understood that other TFT active matrix backplanes could be devised and the above embodiment is for purposes of example only. Because of the memory of the light transmittance light valves, devices such as low performance, low cost TFTs or the previously described TFDs can be used in the active matrix, which substantially reduces material and manufacturing costs. Also, as described above, the light transmittance of each cell is set to a selected value in the write mode and the active matrix is de-energized in the display mode.

Thus, embodiments of an active matrix for a signage display using light valves with memory have been disclosed. The active matrix with memory is especially useful and convenient when using electrophoretic or electrochromic material in the light valves. The preferred embodiment incorporates only one diode (a data input diode) or one TFT in each pixel which substantially improves the fabrication process. While a specific polarity of diodes and signals is illustrated in the figures for purposes of explanation, it will be understood that the polarity of components and signals can be easily reversed if desired.

In either of the above embodiments, the cost of the external drivers is determined primarily by the number of lines needed rather than the complexity of the drivers. Also, because each of the select and data lines is generally connected to the external drivers by means of bond pads the cost of drivers is, to some extent, bond pad limited, i.e. the cost of drivers is determined by the number of lines. By utilizing demultiplexing (demux) circuits, for example, on the backplane, the number of lines can be reduced by a factor of n. Reducing the number of lines, either or both select lines and data lines, results in a significant saving in the cost of the driver circuitry. It will be understood that demux circuits are optional but are disclosed herein for the benefits possible.

Referring specifically to FIG. 9, a 1×N Demux circuit 150 is illustrated using printed diode and resistor components, which will be described in more detail presently. Circuit 150 has n output lines, designated line 1 through line n, each of which is directly connected to a select line 116 or a data line 120 of backplane 140 in the above embodiment. Each of line 1 through line n is coupled through a resistor 152, 153, 154, and 155, respectively, to a common connection 156. Common connection 156 is connected to the output of a line driver 158 that is generally external to backplane 140 (see driver 16 in FIG. 1). The anodes of diodes 160, 161, 162, and 163 are connected to lines 1 through n, respectively, and the cathodes are connected to control signals S1, S2, S3, and Sn, respectively.

In operation, a negative signal is supplied as each control signal S1 through Sn, except for the line it is desired to connect to driver 158. The negative signals on the cathodes of the diodes turn the diodes on so that they ground the lines to which they are connected. Thus, only the diode without a negative signal on the cathode can supply a drive signal to the selected line. In a typical example, all of the control signals S2 through Sn are held negative so that only diode 160 is non-conducting and, therefore, the driver signal from driver 158 is conducted through resistor 152 to line 1. After a predetermined time, the negative control signal on S2 is removed and a negative control signal is supplied to S1 and S3 through Sn. Thus, the driver signal from driver 158 is conducted through resistor 153 to line 2. In this fashion the driver signal from driver 158 is sequentially stepped through each of line 1 through line n. In this circuit the quiescent level (no signal) is low.

Referring specifically to FIG. 10, another embodiment of a Demux circuit, designated 180, is illustrated by a schematic representation. Demux circuit 180 includes TFTs 182 through 185 connected in n output lines, designated line 1 through line n. Each output line is directly connected to a select line 116 or a data line 120 of backplane 140 in the above embodiment. Each of line 1 through line n is coupled through a TFT 182 through 185, respectively, to a common connection 186. Common connection 186 is connected to the output of a line driver 188 that is generally external to backplane 140 (see driver 16 in FIG. 1). The gates of TFTs 182 through 185 are connected to receive control signals S1, S2, S3, and Sn, respectively. Here it should be noted that only one control signal is applied to one TFT at a time so that only one select line 116 or a data line 120 is connected to line driver 188 at a time.

Thus, color signage displays using light valves that have memory have been disclosed. By using light valves with memory, there is no need to refresh the display and the image can be written at a much slower rate without concern for flickering. Once the light transmittance of each light valve in the array has been selected and the write mode is completed, the active matrix can be de-energized until it is desired to reconfigure the display, at which time the display is energized and another write mode is initiated. As a result, the requirements for the backplane and the driver are substantially relaxed. The driver cost can be further reduced by optionally implementing demux circuits with the back plane technology. The active matrix can be formed using virtually any convenient material as a substrate, for example, glass, quartz, PET, polyimide (PI), etc. Also, the active matrix incorporates thin film components (TFTs or TFDs) which can be fabricated very inexpensively as, for example by printing.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. Reconfigurable color signage comprising:
an array of light valves each having memory, the array having a major viewing surface and a reverse surface, and each light valve of the array of light valves having an adjustable light transmittance;
an active matrix positioned on one of the major viewing surface and the reverse surface of the array and including a plurality of conductive select lines and a plurality of conductive data lines, each light valve of the array of light valves being electrically coupled to one of the plurality of select lines and to one of the plurality of data lines such that each light valve is separately addressable by a unique combination of select line and data line, the active matrix having a write mode in which signals are supplied to each light valve of the array of light valves to provide a selected light transmittance and a display mode in which the memory of each light valve of the array of light valves retains the selected light transmittance after the signals of the write mode have been removed;
a backlight positioned to direct light in a light path through each light valve of the array of light valves in accordance with the selected light transmittance; and
a color filter positioned in the light path, the color filter being formed and positioned to separate light from the light valves of the array of light valves into different colors, whereby transmittance and color of light by each light valve of the array of light valves is reconfigurable to effect signage.

2. Reconfigurable color signage as claimed in claim 1 wherein the active matrix is formed on a transparent substrate.

3. Reconfigurable color signage as claimed in claim 2 wherein the transparent substrate includes one of glass, quartz, and transparent plastic.

4. Reconfigurable color signage as claimed in claim 2 wherein circuitry within the active matrix includes transparent conductors.

5. Reconfigurable color signage as claimed in claim 2 wherein circuitry coupled to the active matrix includes ICs for one of wire and wireless communication whereby the color signage is reconfigured.

6. Reconfigurable color signage as claimed in claim 1 further including a diffuser positioned to diffuse light emanating from the array of light valves and the color filter.

7. Reconfigurable color signage as claimed in claim 6 wherein the color filter is positioned adjacent the major viewing surface of the array of light valves, the backplane is positioned adjacent the rear surface of the array of light valves, the diffuser is positioned on a front surface of the color filter, and the backlight is positioned adjacent a rear surface of the active matrix.

8. Reconfigurable color signage as claimed in claim 1 wherein the light valves of the array of light valves include one of electrophoretic cells and electrochromic cells.

9. Reconfigurable color signage as claimed in claim 1 wherein drivers are coupled to the active matrix through demux circuits.

10. Reconfigurable color signage as claimed in claim 2 wherein the color filter is formed to define a plurality of pixels with one red filter, one green filter, and one blue filter for each pixel, and the red filter, the green filter, and the blue filter of each pixel are each positioned to be illuminated by separate light valves of the array of light valves.

11. Reconfigurable color signage as claimed in claim 1 wherein the active matrix includes a storage capacitor coupled to each light valve to provide write memory.

12. Reconfigurable color signage as claimed in claim 1 wherein the active matrix includes one of thin film diodes and thin film transistors.

13. Reconfigurable color signage comprising:
an array of light valves each having memory, the array having a major viewing surface and a reverse surface, and each light valve of the array of light valves having an adjustable light transmittance;
an active matrix positioned on one of the major viewing surface and the reverse surface of the array and including a plurality of conductive select lines and a plurality of conductive data lines, each light valve of the array of light valves being electrically coupled to one of the plurality of select lines and to one of the data lines such that each light valve is separately addressable by a unique combination of select line and data line, the active matrix having a write mode in which signals are supplied to each light valve of the array of light valves to provide a selected light transmittance and a display mode in which the memory of each light valve of the array of light valves retains the selected transmittance after the signals of the write mode have been removed;
the active matrix being formed on a transparent substrate and including transparent conductors;
a backlight positioned to direct light in a light path through the array of light valves in accordance with the selected light transmittance; and
a color filter positioned in the light path, the color filter being formed and positioned to define a plurality of pixels and including one red filter, one green filter, and one blue filter for each pixel, the red filter, the green filter, and the blue filter of each pixel being formed and positioned to separate light from the light valves of the array of light valves into different colors, whereby transmittance of light by each light valve of the array of light valves is reconfigurable to effect signage.

14. Reconfigurable color signage as claimed in claim 13 wherein circuitry coupled to the active matrix includes ICs for one of wire and wireless communication whereby the color signage is reconfigured.

15. Reconfigurable color signage as claimed in claim 13 further including a diffuser positioned to diffuse light emanating from the array of light valves and the color filter.

16. Reconfigurable color signage as claimed in claim 15 wherein the color filter is positioned adjacent the major viewing surface of the array of light valves, the backplane is positioned adjacent the rear surface of the array of light valves, the diffuser is positioned on a front surface of the color filter, and the backlight is positioned adjacent a rear surface of the active matrix.

17. Reconfigurable color signage as claimed in claim 13 wherein the light valves of the array of light valves include one of electrophoretic cells and electrochromic cells.

18. Reconfigurable color signage as claimed in claim 13 wherein drivers are coupled to the active matrix through demux circuits.

19. Reconfigurable color signage as claimed in claim 13 wherein the active matrix includes a storage capacitor coupled to each light valve to provide write memory.

20. Reconfigurable color signage as claimed in claim 13 wherein the active matrix includes one of thin film diodes and thin film transistors.

21. Reconfigurable color signage comprising:
an array of light valves including one of electrophoretic cells and electrochromic cells each having memory, the array having a major viewing surface and a reverse surface, and each light valve of the array of light valves having an adjustable light transmittance;
an active matrix positioned on one of the major viewing surface and the reverse surface of the array and including a plurality of conductive select lines and a plurality of conductive data lines, each light valve of the array of light valves being electrically coupled to one of the plurality of select lines and to one of the data lines such that each light valve is separately addressable by a unique combination of select line and data line, the active matrix having a write mode in which signals are supplied to each light valve of the array of light valves to provide a selected light transmittance and a display mode in which the memory of each light valve of the array of light valves retains the selected conductivity after the signals of the write mode have been removed;
drivers coupled to one of the select lines and the data lines of the active matrix through demux circuits;
the active matrix being formed on a transparent substrate and including transparent conductors;
a backlight positioned to direct light in a light path through the array of light valves in accordance with the selected light transmittance;
a color filter positioned in the light path, the color filter being formed and positioned to define a plurality of pixels and including one red filter, one green filter, and one blue filter for each pixel, the red filter, the green filter, and the blue filter of each pixel being formed and positioned to separate light from the light valves of the array of light valves into different colors; and
a diffuser positioned to diffuse light emanating from the array of light valves and the color filter whereby transmittance of light by each light valve of the array of light valves is reconfigurable to effect signage.

22. Reconfigurable color signage as claimed in claim 21 wherein circuitry coupled to the drivers includes ICs for one of wire and wireless communication whereby the color signage is reconfigured.

23. Reconfigurable color signage as claimed in claim 21 wherein the active matrix includes one of thin film diodes and thin film transistors.

24. A method of reconfiguring color signage comprising the steps of:
providing an array of light valves each having memory and each light valve of the array of light valves having an adjustable light transmittance, an active matrix positioned in electrical contact with the array and each light valve being separately addressable, the active matrix having a write mode and a display mode in which the memory of each light valve of the array of light valves retains a selected conductivity after signals of the write mode have been removed, a backlight positioned to direct light in a light path through the array of light valves in accordance with the selected light transmittance of each light valve, and a color filter positioned in the light path, the color filter being formed and positioned to define a plurality of pixels and including one red filter, one green filter, and one blue filter for each pixel, the red filter, the green filter, and the blue filter of each pixel each positioned to be associated with a separate light valve of the array of light valves;
energizing the active matrix into the write mode and supplying signals through the active matrix to each light valve of the array of light valves in the write mode to provide a selected light transmittance to each light valve of the array of light valves; and
de-energizing the active matrix into the display mode in which the memory of each light valve of the array of light valves retains the selected transmittance after the signals of the write mode have been removed.
